(19) United States
(12) Patent Application Publication
(10) Pub. No.: US 2024/0338569 A1
(43) Pub. Date: Oct. 10, 2024

(54) ANALYSIS OF INTERESTINGNESS FOR COMPETENCY-AWARE DEEP REINFORCEMENT LEARNING

(71) Applicant: SRI International, Menlo Park, CA (US)

(72) Inventors: Pedro Daniel Barbosa Sequeira, Palo Alto, CA (US); Melinda T. Gervasio, Mountain View, CA (US)

(21) Appl. No.: 18/504,923

(22) Filed: Nov. 8, 2023

Related U.S. Application Data
(60) Provisional application No. 63/430,935, filed on Dec. 7, 2022.

(51) Int. Cl. G06N 3/092

(52) U.S. Cl. CPC G06N 3/092

(57) ABSTRACT

In an example, a method includes, collecting interaction data comprising one or more interactions between one or more Reinforcement Learning (RL) agents and an environment; analyzing interestingness of the interaction data along one or more interestingness dimensions; determining competency of the one or more RL agents along the one or more interestingness dimensions based on the interestingness of the interaction data; and outputting an indication of the competency of the one or more RL agents.

This application claims the benefit of U.S. Patent Application No. 63/430,935, filed Dec. 7, 2022, which is incorporated by reference herein in its entirety.

### GOVERNMENT RIGHTS

This invention was made with Government support under contract number HR001119C0112 awarded by the Defense Advanced Research Projects Agency (DARPA). The Government has certain rights in this invention.

### TECHNICAL FIELD

This disclosure is related to machine learning systems, and more specifically to competency-aware deep reinforcement learning.

### BACKGROUND

Explainable reinforcement learning (xRL) is an emerging field that aims to make reinforcement learning (RL) agents more transparent and understandable. Current systems for xRL are essentially competency unaware. In other words, current systems for explainable RL do not provide a holistic view of the RL agent's abilities and limitations. The xRL systems typically focus on explaining single decisions or providing behavior examples, rather than measuring the agent's competence or understanding of the challenges it experiences. While explaining single decisions or providing behavior examples may be useful for understanding specific agent behaviors, such explanations do not provide a complete picture of the agent's abilities. For example, an xRL system might be able to explain why the RL agent took a particular action in a given situation, but it would not be able to identify the agent's strengths and weaknesses across a variety of situations. This lack of competency awareness may make it difficult for human operators to interact with RL agents effectively.

Without information about agent's specific challenges and limitations, it may be difficult to know what kind of intervention or assistance would be most helpful in determining whether the RL agent is suitable for future deployment. In addition, the lack of competency awareness may make it difficult to trust RL agents in safety-critical applications. For example, if an RL agent is used to control a self-driving car, it is important to be able to trust that the RL agent is capable of making safe decisions in all situations. However, if the RL agent's competency is not well understood, it may be difficult to be confident that the RL agent is reliable enough for use in a real-world setting.

### SUMMARY

The disclosure describes techniques for xRL that are based on analyses of “interestingness.” Interestingness may represent an approximate measure of how surprising or unexpected an action performed by an agent would be given the environment in which the agent operates or generally what a human would find interesting when assessing an agent's competence. The XRL system may use interestingness to identify behaviors that are indicative of the agent's competence, such as behaviors that are rare, difficult to perform, or successful in challenging situations. The described techniques provide different measures of RL agent competence stemming from interestingness analysis. For example, the techniques may be used to measure the agent's: diversity of skills, robustness to perturbations and ability to learn and adapt.

The diversity of skills measure assesses the range of different tasks and situations that the agent is able to handle competently. The robustness to perturbations measure assesses how well the agent may maintain its performance when faced with changes to the environment or its own internal state. The ability to learn and adapt measure assesses how quickly and effectively the agent may learn new skills and adapt to new situations.

The disclosed techniques are also applicable to a wide range of deep RL algorithms. In addition, the disclosed techniques may be used to explain the competence of RL agents that are used in a variety of different applications, such as, but not limited to, robotics, gaming, and finance.

In addition to the measures of competence described above, the present disclosure also describes techniques for assessing RL agents' competencies. These techniques may include but are not limited to: clustering agent behavior traces and identifying the task elements mostly responsible for an agent's behavior. Clustering agent behavior traces techniques may be used to identify agent behavior patterns and competency-controlling conditions. For example, clusters of agent behavior traces may be used to identify the different ways that the agent behaves in different situations, and the factors that influence its performance. Techniques for identifying the task elements mostly responsible for an agent's behavior may be used to identify the parts of a task that are most challenging for the agent. The identified parts of the task may then be used to design targeted interventions or training exercises.

In this respect, various aspects of the techniques provide insights about RL agent competence, both their capabilities and limitations. This information may be used by users to make more informed decisions about interventions, additional training, and other interactions in collaborative human-machine settings. Following are some specific examples of how various aspects of the disclosed techniques. A human operator could use the disclosed system to identify the specific areas where an RL agent needs improvement. The identified information could then be used to design targeted interventions or training exercises. For example, if the system identifies that the agent is having difficulty with a particular type of obstacle, the operator could design a training environment that specifically focuses on that type of obstacle.

A competency-aware xRL system may be used to assess the safety of at least one interaction between an RL agent and the environment before the RL agent is deployed in a real-world setting. The competency-aware xRL system may assess competency of an RL agent by identifying the agent's weaknesses and limitations, and by simulating the agent's performance in a variety of scenarios. For example, if the xRL system identifies that the RL agent is likely to make risky decisions in certain situations, the operator may take steps to mitigate those risks, such as by designing the system to avoid those situations or by implementing safeguards to prevent the agent from causing harm. A competency-aware xRL system could be used to provide feedback to an RL agent during training. Such feedback may help the agent to learn from its mistakes and to improve its performance.

In an example, a method includes, collecting interaction data comprising one or more interactions between one or more Reinforcement Learning (RL) agents and an environment; analyzing interestingness of the interaction data along one or more interestingness dimensions; determining competency of the one or more RL agents along the one or more interestingness dimensions based on the interestingness of the interaction data; and outputting an indication of the competency of the one or more RL agents.

In an example, a computing system comprises: an input device configured to receive interaction data comprising one or more interactions between one or more Reinforcement Learning (RL) agents and an environment; processing circuitry and memory for executing a machine learning system, wherein the machine learning system is configured to: analyze interestingness of the interaction data along one or more interestingness dimensions; determine competency of the one or more RL agents along the one or more interestingness dimensions based on the interestingness of the interaction data; and output an indication of the competency of the one or more RL agents.

In an example, non-transitory computer-readable storage media having instructions encoded thereon, the instructions configured to cause processing circuitry to: collect interaction data comprising one or more interactions between one or more Reinforcement Learning (RL) agents and an environment; analyze interestingness of the interaction data along one or more interestingness dimensions; determine competency of the one or more RL agents along the one or more interestingness dimensions based on the interestingness of the interaction data; and output an indication of the competency of the one or more RL agents.

### Additional Claim Language to be Inserted after First Review

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a diagram illustrating a system networked environment that may provide reinforcement learning via deep learning according to various aspects of the techniques described in this disclosure

FIG. 2 is a block diagram illustrating an example computing system of FIG. 1 in more detail that is configured to perform various aspects of the techniques described in the disclosure.

FIG. 3 is a conceptual diagram illustrating an example framework for analyzing the competence of deep RL agents through interestingness analysis according to techniques of this disclosure.

FIGS. 4A-4C are screenshots illustrating example scenarios where RL agents could be used according to techniques of this disclosure.

FIG. 5 is a conceptual diagram illustrating examples of interestingness profiles for each agent in the different scenarios of FIGS. 4A and 4B according to techniques of this disclosure.

FIG. 6 is a flowchart illustrating an example mode of operation for a machine learning system, according to techniques described in this disclosure.

Like reference characters refer to like elements throughout the figures and description.

### DETAILED DESCRIPTION

The disclosure describes techniques that address the problem of behavior interpretability and competency awareness in deep reinforcement learning. xRL is an emerging field that aims to make RL agents more transparent and understandable. Existing xRL systems may be essentially competency unaware. In other words, current xRL systems may not have a holistic understanding of the agent's capabilities and limitations. For example, existing xRL systems may focus on explaining single decisions or providing behavior examples. Following are some specific examples of how existing xRL systems are competency unaware.

Some types of xRL systems may explain why the agent took a particular action in a given situation, but they may not be able to explain the overall competence by the agent in performing a given task. For example, an xRL system might be able to indicate that turning left is better than turning right at a particular intersection, but not why it is better. In addition, the xRL system may not be able explain why the agent sometimes has difficulty with certain tasks.

Some types of xRL system may provide examples of how the agent behaves in different situations, but they may not be able to explain the agent's reasoning or the factors that influence its behavior. For example, an xRL system might be able to provide examples of how the agent drives in different weather conditions, but the xRL system may not be able to explain why the agent drives differently in different situations. The aforementioned types of xRL systems may be useful for understanding specific agent behaviors, but such XRL systems typically do not provide a complete picture of the agent's abilities. Such lack of competency awareness may make it difficult for human operators to interact with RL agents effectively.

For example, if human operators are trying to help an agent improve its performance, they need to understand the agent's specific challenges and limitations. Without such information, it may be difficult to know what kind of intervention or assistance would be most helpful. In addition, the lack of competency awareness can make it difficult to trust RL agents in safety-critical applications. For example, if an RL agent is used to control a self-driving car, it is important to be able to trust that the agent is capable of making safe decisions in all situations. However, if the agent's competency is not well understood, it may be difficult to be confident that the agent is reliable enough for use in a real-world setting.

The disclosed techniques for competency awareness in deep RL agents revolve around the concept of interestingness, which is what humans would find interesting if they were to analyze agent's competence in the task. The disclosed system implements a set of analyses of interestingness, each measuring competence along a different dimension characterizing the agent's experience with the environment that goes beyond traditional measures of agent task performance. The implemented analyses cover various families of deep RL algorithms and may be compatible with open-source RL toolkits. After extracting interestingness given a deep RL policy, the disclosed techniques analyze the agent's behavior in a task by clustering traces based solely on interestingness, that allows isolating different competency-inducing conditions resulting in different behavior patterns. Additionally, the disclosed techniques allow discovering which task elements impact the agent's behavior the most and under which circumstances.

In particular, feature importance analysis may be conducted via SHapley Additive explanations (SHAP) values to perform global and local interpretation for competency assessment. SHAP values are based on game theory and may assign an importance value to each feature in a model. In other words, the disclosed system and method may perform the following steps: extract interestingness from a deep RL policy, cluster agent behavior traces based on interestingness, and discover which task elements impact the agent's behavior the most and under which circumstances. In other implementations (Local Interpretable Model-agnostic Explanations) LIME technique and/or Saliency maps technique may be used for feature importance analysis.

Interestingness is a measure of how surprising or unexpected an agent's behavior is. Interestingness may be used to identify behaviors that are indicative of the agent's competence, such as behaviors that are rare, difficult to perform, or successful in challenging situations. Clustering agent behavior traces may allow the system to identify different competency-inducing conditions that result in different behavior patterns. Discovery of task elements impacting the agent's behavior the most may be performed using SHAP values, which is a technique for interpreting machine learning models.

The disclosed system and method may be used to address the problem of behavior interpretability and competency awareness in deep RL by providing insights into the agent's capabilities and limitations. Competency awareness may be used by users to make more informed decisions about interventions, additional training, and other interactions in collaborative human-machine settings.

Following are some specific examples of how the disclosed system and method could be used. A human operator could use the disclosed system to identify the specific areas where an RL agent needs improvement. The identified areas could then be used to design targeted interventions or training exercises. For example, if the system identifies that the agent is having difficulty with a particular type of obstacle, the operator could design a training environment that specifically focuses on that type of obstacle. As another non-limiting example, a competency-aware xRL system could be used to assess the safety of at least one interaction between an RL agent and the environment before the RL agent is deployed in a real-world setting. Such assessment may be implemented by identifying the agent's weaknesses and limitations, and by simulating the agent's performance in a variety of scenarios. For example, if the system identifies that the agent is likely to make mistakes in certain situations, the operator could take steps to mitigate those risks, such as by designing the system to avoid those situations or by implementing safeguards to prevent the agent from causing harm. As yet another non-limiting example, a competency-aware xRL system could be used to provide feedback to an RL agent during training. The feedback could help the agent to learn from its mistakes and to improve its performance. For example, if the system identifies that the agent is making a mistake, the system could provide the agent with a corrective signal or with advice on how to avoid making the same mistake in the future.

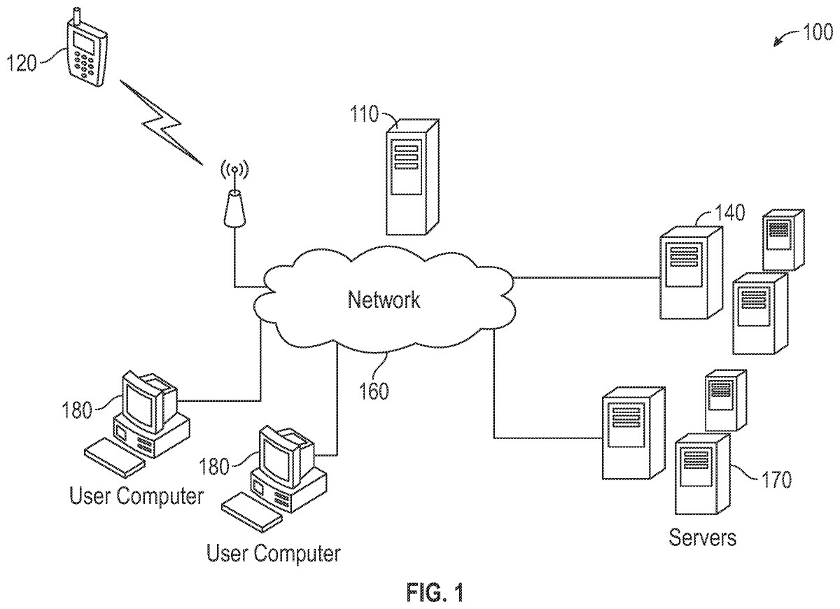

In summary, the disclosed system and method for competency awareness in deep RL agents implements a new set of analyses of interestingness that work with a broad range of RL agents/algorithms. In addition, the disclosed system may be used to assess the competency of RL agents that are used in a variety of different applications, such as, but not limited to, robotics, gaming, and finance. The disclosed system and method also provide new ways of using interestingness for competency self-assessment that go beyond behavior summarization. A deep learning system that utilizes reinforcement learning methods in accordance with the techniques of the disclosure is shown in FIG. 1.

FIG. 1 is a diagram illustrating a system networked environment that may provide reinforcement learning deep learning according to various aspects of the techniques described in this disclosure. A computing system 100 may include a communications network 160. The communications network 160 may be a network such as the Internet that allows devices connected to the network 160 to communicate with other connected devices. Server systems 110, 140, and 170 may be connected to the network 160. Each of the server system 110, 140, and 170 may be a group of one or more servers communicatively connected to one another via internal networks that execute processes that provide cloud services to users over the network 160. For purposes of the present disclosure, cloud services are one or more applications that are executed by one or more server systems to provide data and/or executable applications to devices over a network. The server systems 110, 140, and 170 are shown each having three servers in the internal network. However, the server systems 110, 140 and 170 may include any number of servers and any additional number of server systems may be connected to the network 160 to provide cloud services. In accordance with various aspects of the present disclosure, a deep learning system that utilizes reinforcement learning methods in accordance with the techniques of the disclosure may be provided by process being executed on a single server system and/or a group of server systems communicating over network 160.

Users may use personal devices 180 and 120 that connect to the network 160 to perform processes for providing and/or interaction with a deep learning system that utilizes reinforcement learning methods in accordance with the techniques of the disclosure. In an aspect, personal devices 180 and 120 may be configured to collect interaction data comprising one or more interactions between one or more RL agents and an environment; analyze interestingness of the interaction data along one or more interestingness dimensions; determine competency of the one or more RL agents along the one or more interestingness dimensions based on the interestingness of the interaction data; and output an indication of the competency of the one or more RL agents.

In the shown implementation, the personal devices 180 are shown as desktop computers that are connected via a conventional “wired” connection to the network 160. However, the personal device 180 may be a desktop computer, a laptop computer, a smart television, an entertainment gaming console, or any other device that connects to the network 160 via a “wired” connection. The mobile device 120 connects to network 160 using a wireless connection. A wireless connection is a connection that uses Radio Frequency (RF) signals, Infrared signals, or any other form of wireless signaling to connect to the network 160. In FIG. 1, the mobile device 120 is a mobile telephone. However, mobile device 120 may be a mobile phone, a tablet, a smartphone, or any other type of device that connects to network 160 via wireless connection without departing from aspects of this disclosure.

It is to be further understood that, because some of the constituent system components and method steps depicted in the accompanying figures may be implemented in software, the actual connections between the systems components (or the method steps) may differ depending upon the manner in which the present disclosure is programmed. Given the teachings of the present disclosure provided herein, one of ordinary skill in the related art will be able to contemplate these and similar implementations or configurations of the present disclosure.

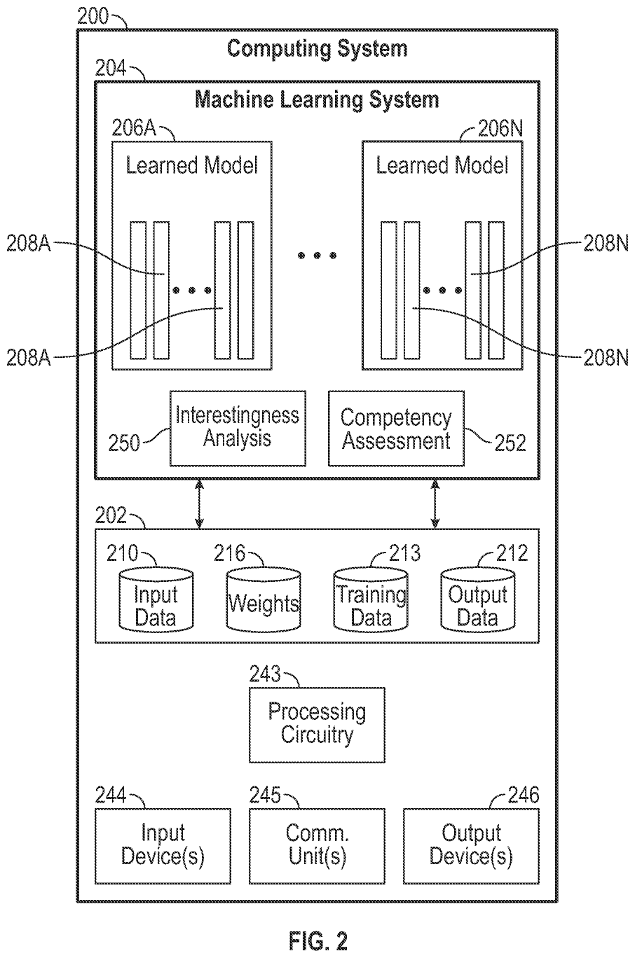

FIG. 2 is a block diagram illustrating an example computing system 200. In an aspect, computing system 200 may comprise an instance of the deep learning system that may be executed on any of the server systems 110, 140 or 170 of FIG. 1.

Reinforcement learning (RL) is a machine learning technique that allows autonomous agents to learn sequential decision tasks through trial-and-error interactions with dynamic and uncertain environments. RL problems may be framed under the Markov decision process (MDP) formulation, which is a tuple consisting of the following elements: S, A, P, R, γ, ρ0, where: S is the set of environment states, A is the set of agent actions, P(s′|s, a) is the probability of the agent visiting state s′ after executing action a in state s, R(s, a) is the reward function, which dictates the reward that the agent receives for performing action a in state s, γ is a discount factor denoting the importance of future rewards, and ρ0 is the starting state distribution. The goal of an RL agent is to learn a policy, which is a mapping from states to actions, that maximizes its expected reward over time. The agent may learn to improve its policy by interacting with the environment and receiving rewards and punishments.

RL agents have been successfully applied to a wide range of tasks, including, but not limited to, video games, robotics, and finance. However, one of the challenges of RL is that it may be difficult to assess the competence of an RL agent because RL agents are often black boxes. In other words, it may be difficult to understand how RL agents make their decisions.

A potential goal of an RL algorithm is to learn a policy, which is a mapping from states to actions, which maximizes the expected return for the agent, i.e., the discounted sum of rewards the agent receives during its lifespan. This optimization problem may be represented by the following formula (1):

$$π * = arg max π E [ Pt γ tRt ] \qquad ( 1 )$$

where π* is the optimal policy, Rt is the reward received by the agent at discrete timestep t and γ is a discount factor denoting the importance of future rewards. RL algorithms may use an auxiliary structure called the value function to help learn a policy. The value function, denoted by Vπ(s), estimates the expected return that the agent will receive by being in state s and following policy x thereafter. The value function may be represented by the following formula (2):

$$V π ( s ) = E [ \sum t = 0 γ tRt \vert S 0 = s ] \qquad ( 2 )$$

In deep RL, policies and other auxiliary structures are represented by neural networks. The parameters (or, in other words, weights 216) of these neural networks are adjusted during training to change the agent's behavior via some RL algorithm. These neural networks are referred to as the learned models. The adjustment of parameters may be implemented by using a variety of different techniques. One common approach is to use a technique called policy gradient. Policy gradient methods adjust the parameters of the RL policy in the direction that increases the expected reward of the agent. The parameters of the RL policy may be adjusted to improve the agent's performance in the environment.

As shown, computing system 200 comprises processing circuitry 243 and memory 202 for executing a machine learning system 204 having one or more neural networks 206A-206N optimized via deep RL (collectively, “learned models 206”) comprising respective sets of layers 208A-208N (collectively, “layers 208”). Each of learned models 206 may comprise various types of neural networks, such as, but not limited to, deep neural networks such as, but not limited to, recursive neural networks (RNNs) convolutional neural networks (CNNs) and feed forward neural networks.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system may represent an instance of computing system 100 of FIG. 1.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, interestingness analysis module 250, competency assessment module 252) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., interestingness analysis module 250 and competency assessment module 252), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

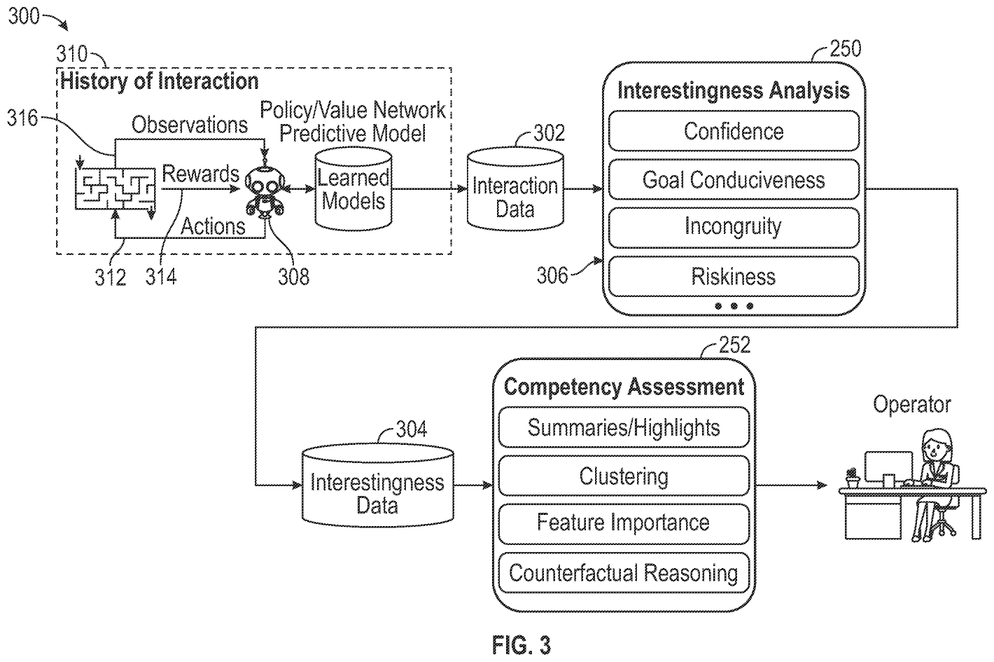

In the example of FIG. 2, interestingness analysis module 250 may receive input data from an input data set 210 and may generate output data 212. Input data 210 and output data 212 may contain various types of information. For example, input data 210 may include interaction data 302 described below in conjunction with FIG. 3. Output data 212 may include interestingness data 304, agent's competence information, agent's capabilities information and so on.

Each set of layers 208 may include a respective set of artificial neurons. Layers 208A for example, may include an input layer, a feature layer, an output layer, and one or more hidden layers. Layers 208 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer. Various activation functions are known in the art, such as Rectified Linear Unit (ReLU), TanH, Sigmoid, and so on.

Machine learning system 204 may process training data 213 to train deepRL policy, in accordance with techniques described herein. For example, machine learning system 204 may apply an end-to-end training method that includes processing training data 213. It should be noted that in various aspects another computing system may train the deepRL policy.

Machine learning system 204 may process input data 210 to generate agent's competency information as described below. In an aspect, the interestingness analysis module 250 may analyze trained RL policies along various interestingness dimensions. By analyzing a plurality interestingness dimensions, the interestingness analysis module 250 may develop a more comprehensive understanding of an agent's competence. Furthermore, the machine learning system 204 may provide a method to discover which task elements impact agent's behavior the most and under which circumstances. In an aspect, this method may be implemented by the competency assessment module 252. For example, the competency assessment module 252 may identify situations where the RL agent is making risky decisions or where the RL agent is struggling to adapt to changes in the environment. Additional details of these modules 250 and 252 are discussed in connection with FIG. 3.

In an aspect, the machine learning system 204 may provide new ways of using interestingness for competency self-assessment that go beyond behavior summarization. In particular, the machine learning system 204 may identify scenarios within a task where the agent behaves differently, and it may determine the conditions that lead to these different behaviors. Such information may be used to help users identify the areas where the agent needs improvement, and to design targeted interventions or training exercises. In addition, the machine learning system 204 may provide new interpretation methodologies based on SHAP values for interestingness prediction. The disclosed techniques may allow users to determine the most competency-controlling elements of the task, and to analyze particular situations. Competency-controlling elements are the aspects of a task that are most important for the agent to be successful. Competency-controlling elements may include factors such as the agent's goals, the agent's environment, or the agent's performance. For example, if the system detects that the agent is significantly less confident about what to do in situations where an obstacle is present, SHAP values may be used to deem the presence of an obstacle as a competency-controlling condition. In that case, the agent's relative performance may be assessed by comparing the agent's performance in traces where an obstacle is present and traces where there are no obstacles, thus assessing the agent's ability in dealing with obstacles. Identifying competency-controlling elements is an important step in determining the competency of RL agents. The analyzed information may be used to help users understand why the agent is behaving in a certain way, and to identify potential ways to improve its performance.

In an aspect, the machine learning system 204 may provide a more holistic view of RL agents' competence. In other words, the machine learning system 204 may give users a better understanding of the agent's capabilities and limitations, as well as the challenges it experiences. Information related to agents' capabilities may be used by users to make more informed decisions about how to interact with and use RL agents. For example, users may use the aforementioned information to: decide whether to deploy an agent, decide when to follow the agent's decisions/recommendations, help the agent improve its performance. If users understand the agent's capabilities and limitations, they may make a more informed decision about whether to deploy the agent in a particular situation. For example, if users know that an agent is not good at handling certain types of situations, they may choose not to deploy the agent in those situations.

Even if users choose to deploy an agent, they may not want to follow the agent's decisions/recommendations in all situations. For example, if users know that an agent is not good at handling certain types of situations, they may choose to override the agent's decision in those situations. If users understand the challenges that an agent is facing, they may design interventions or training exercises to help the agent improve its performance. Overall, the machine learning system 204 may help to increase trust in autonomous AI systems by providing users with a better understanding of the agent's capabilities and limitations. Agent's capabilities information may then be used to make more informed decisions about how to interact with and use the agent.

Following are some specific examples of how the machine learning system 204 could be used to increase trust in autonomous AI systems. If learned models 206 are components of a self-driving vehicle, a human operator could use the machine learning system 204 to understand the capabilities and limitations of the self-driving vehicle before they get in the car. The capabilities and limitations information could then be used to make informed decisions about when to follow the vehicle's recommendations and when to override them. In another non-limiting example, if learned models 206 are components of a robotic surgery system, surgeons could use the machine learning system 204 to understand the capabilities and limitations of the robotic surgery system before they use it to perform surgery. The capabilities and limitations information could then be used to make informed decisions about when to follow the system's recommendations and when to override them. Learned models 206 may also be used to manage the energy consumption of an HVAC system by analyzing the capabilities and limitations of the system, by predicting the energy needs of the system and by adjusting the settings of the system to minimize energy consumption, for example.

In yet another non-limiting example, if learned models 206 are components of a fleet of autonomous drones, military commanders could use the machine learning system 204 to understand the capabilities and limitations of the fleet of autonomous drones before they send the drones on a mission. The capabilities and limitations information could then be used to make informed decisions about what tasks to assign to the drones and how to monitor their performance.

In general, agents of a competency aware deep xRL system may be evaluated on the following criteria: correctness, performance and usability. Correctness evaluation may involve evaluation of whether users can correctly identify an agent's capabilities and limitations by ingesting and visualizing the data produced by the machine learning system 204. Correctness may be assessed through surveys, interviews, or other methods for collecting user feedback. Performance evaluation may involve evaluation of how much cost was avoided by alerting the user, or how much a user intervention improved performance. Performance may be measured by tracking the agent's performance in real-world applications, or by running simulations. Tracking performance in real-world applications is the most accurate way to measure the agent's competency, as it reflects how well the agent performs in the real world. However, it may be difficult and expensive to track the performance of an agent in real-world applications, especially for complex tasks. Running simulations is a more efficient way to measure the agent's competency, as it allows the agent to be evaluated in a variety of environments and conditions. However, simulations may be less accurate than real-world evaluations, as they may not perfectly replicate the real world. The best way to measure the performance of an RL agent depends on the specific task and the available resources.

Usability evaluation may involve evaluation of how many alerts were ignored by the user, or how easy it is for users to understand and use the information provided by the machine learning system 204. Usability may be assessed through surveys, interviews, or other methods for collecting user feedback.

In addition to the aforementioned general criteria, the learned models 206 may also be evaluated on specific criteria that are relevant to the particular application. For example, learned models 206 for a self-driving vehicle might be evaluated on safety and efficiency. Safety evaluation may involve evaluation of how often does the learned model 206 (i.e., competency aware xRL system) alerts the user to potential safety hazards and/or how accurately does the learned model 206 assess the severity of safety hazards. Efficiency evaluation may involve evaluation of how often does the learned model 206 alert users to situations where they can intervene to improve the efficiency of the vehicle's driving and/or how accurately does the learned model 206 assess the potential benefits of user intervention.

In an aspect, the disclosed computing system 200 has several advantages including, but not limited to: early detection of problems with the agents' policy and improved decision-making for operators and teammates. The machine learning system 204 may be used to detect problems with the agent's policy early, prior to deployment. Such detection may be very important in industrial settings, where the cost of deploying an agent with a faulty policy may be very high. For example, if an RL agent is used to control a manufacturing process, a faulty policy could lead to product defects or even accidents. By detecting problems with the policy early, the disclosed machine learning system 204 may help to avoid these costly problems. In another example, the machine learning system 204 may help operators and teammates to make better decisions about when to deploy the agent or follow its recommendations. Deployment decisions may be especially important in safety-critical applications, such as military settings. For example, if an RL agent is used to control a fleet of autonomous drones, the machine learning system 204 may help operators to decide when it is safe to deploy the drones and when it is not.

In addition to the aforementioned advantages, the machine learning system 204 may also be used to improve the performance of RL agents by helping to identify areas where the agent needs improvement. Identified information may then be used to design targeted interventions or training exercises. Overall, the machine learning system 204 has the potential to significantly improve the safety, reliability, and performance of RL agents in a variety of industrial settings. Following are some specific examples of how the machine learning system 204 could be used to improve safety and reliability in industrial and military settings. A manufacturing company could use the machine learning system 204 to detect problems with the policy of an RL agent that is used to control a manufacturing process. By detecting problems with the policy early, the company may avoid product defects and accidents. The machine learning system 204 may help operators decide when it is safe to deploy one or more autonomous drones for many types of applications. The machine learning system 204 may also be used to identify areas where the drones need improvement, such as their ability to avoid obstacles in certain environments.

There is a growing need to make deep learning models understandable by humans because deep learning models are becoming increasingly complex and are being used in a wider range of applications. As a result, it may be important for humans to be able to understand how these models work and what their capabilities and limitations are. Deep learning models are often used in safety-critical applications, such as, but not limited to, self-driving vehicles and medical diagnosis systems. In the aforementioned applications, it may be important for humans to be able to understand how the models work and what their limitations are so that they can be confident in the safety of the systems.

Contemporary deep learning models are often used to make decisions that have a significant impact on people's lives. For example, deep learning models may be used to approve loans, hire employees, and target advertising. In these cases, it may be important for humans to be able to understand how the models work so that humans determine if some models are unsuitable for deployment in certain tasks. People are more likely to trust and use deep learning models if they understand how they work. Such understanding is especially important in areas such as, but not limited to, healthcare and finance, where people need to have a high level of trust in the systems that they are using.

By making deep learning models understandable by humans, companies may improve the safety, transparency, and trust of their AI systems. Making deep learning models understandable by humans may lead to a number of benefits, including, but not limited to: increased customer satisfaction, reduced regulatory risk, improved employee productivity, better business decisions. In addition, competency awareness in deep RL agents may be applied to collaborative human-machine teams where humans need to trust, understand, and predict the behavior of their artificial partners. This is an active area of interest because collaborative human-machine teams are becoming increasingly common in a variety of industries, such as, but not limited to, healthcare, manufacturing, and transportation. In order for humans to trust, understand, and predict the behavior of their artificial partners, they need to have a good understanding of the agent's capabilities and limitations. The machine learning system 204 may provide this information by identifying the agent's strengths and weaknesses, as well as the conditions that lead to different behavior patterns.

Information provided by the machine learning system 204 may be used by humans to make more informed decisions about how to interact with and use the agent. For example, if humans know that an agent is not good at handling certain types of situations, they may avoid putting the agent in those situations.

FIG. 3 is a conceptual diagram illustrating an example framework for analyzing the competence of deep RL agents through interestingness analysis according to techniques of this disclosure. As noted above, the black box problem is a major challenge for the wider adoption of RL techniques in critical settings. When humans do not understand how an RL agent makes its decisions, it may be difficult to trust it to make safe and reliable decisions in real-world applications. There are a number of approaches that are being explored to address the black box problem in RL.

One approach is to develop interpretable RL algorithms. Interpretable RL algorithms aim to learn models that are more transparent and easier to understand, while still maintaining good performance. Another approach is to develop methods for verifying the safety and reliability of RL agents. These methods may be used to test RL agents in a variety of scenarios to identify potential problems and ensure that they meet desired safety and reliability standards.

Model-based RL algorithms learn a model of the environment and use it to plan their actions. Model-based RL algorithms may make it easier to understand how the agent makes its decisions, since the model may be inspected to see how the agent is reasoning about the environment. Policy gradient methods may be used to learn policies that are directly interpretable, such as linear policies or policies that are represented by decision trees. Formal verification techniques may be used to prove that an RL agent will satisfy certain safety and reliability properties. Formal verification techniques may be implemented by constructing a formal model of the agent and the environment, and then using formal verification tools to prove that the model satisfies the desired properties.

Testing may be used to check the safety and reliability of an RL agent in a variety of scenarios. Testing may be implemented by simulating the agent's interactions with the environment and observing its behavior.

If the agent makes a poor decision, it may be difficult to debug the agent if humans do not understand how it makes its decisions.

There are a number of approaches that are being explored to address the black box problem in RL. One approach is to develop interpretable RL algorithms. Interpretable RL algorithms aim to learn models that are more transparent and easier to understand, while still maintaining good performance. Another approach is to develop techniques for verifying the safety and reliability of RL agents. These techniques may be used to test RL agents in a variety of scenarios to identify potential problems and ensure that they meet desired safety and reliability standards.

In contrast to the aforementioned approaches, the framework 300 provides new techniques for assessing the competence of RL agents through self-assessment (introspection) over their history of interaction with the environment. The disclosed techniques are motivated by the need for a more complete understanding of agents' competence, both in terms of their capabilities and limitations, in order to facilitate their acceptance by human collaborators.

The disclosed techniques are based on the idea that insights into an agent's competence may be gained by analyzing agent's behavior over time and identifying patterns in agent's decision-making. In an aspect, the interestingness analysis module 250 may analyze trained RL policies along various interestingness dimensions 306, such as, but not limited to: confidence (how confident is the agent in its action selections?), riskiness (does the agent recognize risky or unfamiliar situations?), goal conduciveness (how “fast” the agent is moving towards or away from the goal?), incongruity (how resilient is the agent to errors and unexpected events?), and the like.

By analyzing a plurality interestingness dimensions 306, the interestingness analysis module 250 may develop a more comprehensive understanding of an agent's competence. Agent's competence information may then be used to direct end-users of the RL system towards appropriate intervention, such as, but not limited to: identifying sub-task competency (the situations in which the agent is more/less competent), highlighting the situations requiring more training or direct guidance, providing early warning signs of potential problems. Overall, the goal of the framework 300 is to make RL agents more trustworthy and reliable for use in critical settings by providing humans with a deeper understanding of their competence.

The framework 300 is referred to hereinafter as IxDRL (Interestingness analysis for explainable Deep RL). The IxDRL framework 300 for competency-aware deep RL agents is a novel framework for analyzing the behavior of deep RL agents through the lens of interestingness.

In an aspect, a trained deep RL policy may be input into the IxDRL framework 300. The agent 308 may be deployed in the environment a number of times under different initial conditions, resulting in a set of traces comprising the agent's history of interaction 310 with the environment from which the agent's competence will be analyzed. As shown in FIG. 3, as the agent 308 interacts with the environment, various information about agent's behavior and internal state may be collected. This collected information is referred to hereinafter as the interaction data 302. The interaction data 302 may include a variety of information, such as, but not limited to: the state of the environment at each timestep, the action 312 taken by the agent 308 at each timestep, the reward 314 received by the 308 agent at each timestep, and the like. The interaction data 302 may be collected using a variety of methods. One common method is to use a simulator to create a virtual environment in which the agent 308 may interact. Another method is to deploy the agent 308 in the real world and collect the interaction data 302 as the agent 308 interacts with the environment.

Distinct RL algorithms make use of different models to optimize the agent's policy during training. In an aspect, the interestingness analysis module 250 may extract the interaction data 302 from four main families of RL algorithms.

Policy gradient algorithms train a policy function that maps from observations 316 to distributions over the agent's actions 312. The policy function is updated using policy gradients, which measure the expected change in the agent's reward 314 with respect to the policy. Value based algorithms train a value function, which estimates the expected return that the agent 308 will receive from a given state. The value function is updated using Bellman's equation, which recursively decomposes the value of a state into the expected value of the next state plus the immediate reward 314. Model-based algorithms learn a model of the environment's dynamics, which may be used to simulate the environment and collect samples. The model is updated using data from the real world or from simulations. Distributional RL algorithms train distributions over values instead of point predictions. Such distributions allow them to capture uncertainty around the estimates. In an aspect, the interestingness analysis module 250 may extract the interaction data 302 from both the internal state of the RL agent 308 and the external environment. The following is a non-limiting list of some of the interaction data 302 that may be extracted. More specifically, the interaction data 302 may include, but is not limited to the following internal agent data: the value of the agent's state according to the learned value function, the probability distribution over actions according to the learned policy function, the entropy of the agent's policy distribution. Furthermore, the interaction data 302 may include, but is not limited to, the following external environmental data: the reward 314 received by the agent 308, the selected action 312, the agent's observation 316. The interaction data 302 may be used to analyze the agent's competence in a number of ways. For example, the interaction data 302 may be used to identify the situations in which the agent 308 is most likely to make mistakes, or to identify the areas where the agent 308 needs to be improved. The interaction data 302 may also be used to develop strategies for improving the agent's competence and making it more trustworthy in real-world settings.

In an aspect, the interestingness analysis module 250 may perform interestingness analysis along several dimensions 306 on the interaction data 302, resulting in a scalar value for each timestep of each trace. In an aspect, the interestingness analysis module 250 may perform interestingness analysis on the timeseries data that defines the traces of behavior in performing a task. For example, the interaction data 302 for a RL agent playing a game may include the following information for each timestep: the agent's current state, the agent's chosen action, the reward received by the agent, the agent's estimated value of the current state. The interestingness analysis module 250 may then perform the interestingness analysis on this timeseries data to generate a scalar value associated with the one or more interestingness dimension 306 for each time step. The resultant scalar value is referred to as the interestingness data 304. The competency assessment module 252 may perform competency assessment based on the interestingness data 304 using various techniques. The IxDRL framework 300 may be designed to provide end-users of deep RL systems with a deeper understanding of the competence of their agents.

The IxDRL framework 300 may be used to identify sub-task competency. In other words, the IxDRL framework 300 may be used to identify the situations in which the agent 308 is more/less competent. The identified information may be used to develop more effective training strategies and to guide the use of the agent 308 in real-world applications. Furthermore, the IxDRL framework 300 may be used to identify the situations in which the agent 308 is more likely to make mistakes. Information about such situations may be used to provide the agent 308 with additional training or to guide the use of the agent in real-world applications.

In addition to the general interestingness dimensions 306 mentioned above (confidence, riskiness, goal conduciveness and incongruity), the interestingness analysis module 250 may also analyze a number of dimensions that are specific to certain families of deep RL algorithms. For example, for policy gradient methods, the interestingness analysis module 250 may analyze dimensions 306 that capture the agent's policy entropy and the gradient of the policy loss function. For model-based RL methods, the interestingness analysis module 250 may analyze dimensions 306 that capture the accuracy of the agent's model of the environment and the agent's reliance on the model. In an aspect, the implementation of the IxDRL framework 300 may be compatible with popular RL toolkits such as, but not limited to, Ray RLlib and PettingZoo. Such compatibility may make it easy for researchers and practitioners to use the IxDRL framework 300 to analyze the behavior of their own deep RL agents.

In an aspect, the analysis performed by the interestingness analysis module 250 may be designed to be applicable to a wide range of tasks and cover a variety of the existing deep RL algorithms. In an aspect, analysis of each interestingness dimension 306 may produce a scalar value in the [−1, 1] interval, where a value of 1 indicates high interestingness and a value of −1 indicates low interestingness. The interestingness analysis module 250 may also restrict the analyses to have access only to the data provided up to a given timestep, so that they may be computed online while the agent 308 is performing the task. The following is a description of the goal behind each interestingness dimension 306 and the corresponding dimension's mathematical realization in the analysis performed by the interestingness analysis module 250.

The Value dimension may characterize the long-term importance of a situation as ascribed by the agent's value function. The Value dimension may be used to identify situations where the agent 308 is near its goals (maximal value) or far from them (low value). The Value dimension may be computed using the following formula (3):

$$V ( t ) = 2 * ( {V}_{[ 0 ; 1 ]}^{π} ( {s}_{t} ) ) - 1 \qquad ( 3 )$$

where V(t) is the value interestingness dimension at discrete timestep t, V^{π} is the agent's value function associated with policy π and V_{[0;1]} is the normalized value function obtained via min-max scaling across all timesteps of all traces. The normalized value function may be obtained by scaling the value function to the range [0, 1] to make the value function comparable across different traces and episodes. The Value dimension may produce a scalar value in the [−1, 1] interval, where a value of 1 indicates that the agent is near its goal and a value of −1 indicates that the agent is far from its goal. The Value dimension may be used to identify situations where the agent 308 is struggling to make progress towards its goal. For example, if the Value dimension is consistently low for a particular state, the agent 308 may be having difficulty reaching that state from other states. The Value dimension may also be used to identify situations where the agent 308 is at risk of failing to achieve its goal. For example, if the Value dimension is suddenly low, the agent 308 may have entered a state from which it is difficult to recover.

The confidence dimension may measure the agent's confidence in its action selection. The confidence dimension may be useful for identifying good opportunities for requesting guidance from a human user or identifying sub-tasks where the agent 308 may require more training. For discrete action spaces, the confidence dimension may be computed using Pielou's evenness index, which measures the normalized entropy of a discrete distribution. Pielou's evenness index may be computed using the following formula (4):

$$J ( X ) = - 1 / log n * {\sum }_{-} i P ( xi ) * log ( P ( xi ) \qquad ( 4 )$$

Where X is the discrete distribution, n is the number of elements in the distribution, P(xᵢ) is the probability of element xᵢ. The confidence dimension may then be computed using the following formula (5):

$$C ( t ) = 1 - 2 * J ( π \text{(*} \vert {s}_{t} ) ) , \qquad ( 5 )$$

Where C(t) is the confidence dimension at timestep t, π(*|st) is the probability distribution over actions at timestep t according to policy π. For continuous action spaces, the confidence dimension may be computed using the relative entropy-based dispersion coefficient. The relative entropy-based dispersion coefficient is a measure of the dispersion of a multivariate Gaussian distribution. The confidence dimension may produce a scalar value in the [−1, 1] interval, where a value of 1 indicates high confidence and a value of −1 indicates low confidence. The confidence dimension may be used to identify situations where the agent 308 is unsure of its best course of action. For example, if the confidence dimension is low for a particular state, the agent 308 may not be confident in its ability to select the best action 312 in that state. The confidence dimension may also be used to identify situations where the agent 308 is struggling to learn a particular task. For example, if the confidence dimension is consistently low for a particular sub-task, the agent 308 may need more training on that sub-task.

The goal conduciveness dimension may assess the desirability of a situation for the agent 308 given the context of the decision at that point, i.e., the preceding timesteps leading up to the current state. Intuitively, the goal conduciveness may calculate how “fast” the agent 308 is moving towards or away from the goal. Decreasing values may be particularly interesting. The interestingness analysis module 250 may also capture large differences in values, which potentially identify external, unexpected events that would violate operator's expectations and where further inspection may be required. The goal conduciveness dimension may be computed using the following formula (6):

$$G ( t ) = sin ( arc tan ( ρ d / {dtV}_{[ 0 ; 1 ]} ( {s}_{t} ) ) ) \qquad ( 6 )$$

where G(t) is the goal conduciveness dimension at timestep t, V_{[0;1]} (sₜ) is the normalized value function at state sₜ, ρ is a scaling factor to make the slope more prominent, d/dt V_{[0:1]}(sₜ) is the first derivative of the value function with respect to time at t. The first derivative of the value function may be approximated using a finite difference numerical method. The sine of the angle generated by the slope may be used for normalization. The goal conduciveness dimension may produce a scalar value in the [−1, 1] interval, where a value of 1 indicates that the agent 308 is moving quickly towards its goal and a value of −1 indicates that the agent 308 is moving quickly away from its goal. The goal conduciveness dimension may be used to identify situations where the agent 308 is making good or bad progress towards its goal. For example, if the goal conduciveness dimension is consistently high, the agent 308 may be making good progress towards its goal. However, if the goal conduciveness dimension suddenly drops, the agent 308 may be at risk of failing to achieve its goal. The goal conduciveness dimension may also be used to identify situations where the agent 308 is facing unexpected events. For example, if the goal conduciveness dimension changes significantly even though the agent 308 is following its policy, the agent 308 may had encountered an unexpected event.

The incongruity dimension may capture internal inconsistencies with the expected value of a situation, which may indicate unexpected situations, e.g., where the reward 314 is stochastic or very different from the one experienced during training. In turn, a prediction violation identified through incongruity may be used to alert a human operator about possible deviations from the expected course of action. Formally, the incongruity dimension may be computed using the following formula (7):

$$I ( t ) = ( {r}_{t} + γ {V}_{[ 0 ; 1 ]}^{π} ( {s}_{t} ) ) - {V}_{[ 0 ; 1 ]}^{π} ( {s}_{t - 1} ) ) / reward\_range \qquad ( 7 )$$

where I(t) is the incongruity dimension at timestep t, rₜ is the reward 314 received at timestep t, V^{π}_{[0;1]} (sₜ) is the value of state sₜ according to policy π, V^{π}_{[0;1]} (sₜ₋₁) is the value of state sₜ₋₁ according to policy π, reward_range is the range of rewards observed from the task. The incongruity dimension is normalized by dividing it by the reward range. Such normalization may make the incongruity dimension comparable across different tasks. The incongruity dimension may produce a scalar value in the [−1, 1] interval, where a value of 1 indicates high incongruity and a value of −1 indicates low incongruity. The incongruity dimension may be used to identify situations where the agent 308 is experiencing something unexpected. For example, if the incongruity dimension is high, the agent 308 may be experiencing a reward 314 that is very different from the one it expected. The reward 314 could be different due to a change in the environment or to a mistake made by the agent 308. The incongruity dimension may also be used to identify situations where the agent 308 is struggling to learn a particular task. For example, if the incongruity dimension is consistently high for a particular sub-task, the agent 308 may be having difficulty learning that sub-task.

The riskiness dimension may quantify the impact of the “worst-case scenario” at each step, highlighting situations where performing the “right” vs. the “wrong” action 312 may dramatically impact the outcome. The riskiness dimension is best computed for value-based RL algorithms by taking the difference between the value of the best action 312, max_{a1€A} Q(a|sₜ) and the worst, min_{a€A}Q(a|sₜ). However, if the interestingness analysis module 250 uses a policy-gradient algorithm that updates the policy directly, the interestingness analysis module 250 may compute the riskiness dimension using the following formula (8):

$$R ( t ) = 2 ( {max}_{a 1 A} π ( {a}_{1} \vert {s}_{t} ) - {max}_{a 2 A} π ( {a}_{2} \vert {s}_{t} ) ) ) - 1 , a 1 \neq a 2 \qquad ( 8 )$$

Where R(t) is the riskiness dimension at timestep t, π(a₁|sₜ) is the probability of taking action a₁ at timestep t according to policy π and π(a₂|sₜ) is the probability of taking action a₂ at timestep t according to policy π. The riskiness dimension may produce a scalar value in the [−1, 1] interval, where a value of 1 indicates high riskiness and a value of −1 indicates low riskiness. The riskiness dimension may be used to identify situations where the agent 308 is facing a lot of uncertainty. For example, if the riskiness dimension is high, the agent 308 may be in a situation where a small mistake could have a big impact on the outcome. The riskiness dimension may also be used to identify situations where the agent 308 is making risky decisions. For example, if the riskiness dimension is high even though the agent 308 is following its policy, the agent 308 may be making a risky decision.

The stochasticity dimension may capture the environment's aleatoric uncertainty. The environment's aleatoric uncertainty is the statistical uncertainty representative of the inherent system stochasticity, i.e., the unknowns that differ each time the same experiment is run. The stochasticity dimension may be best computed for algorithms that model the uncertainty of the agent's environment, such as distributional RL algorithms. For learned models parameterizing discrete distributions of the Q-function, the stochasticity dimension may be computed using the following formula (9):

$$S ( t ) = 1 / ( \vert A \vert ) 1 / \vert A \vert {\sum }_{-} ( a A ) 1 - 4 \vert D ( Q π ( \cdot \vert st ) ) - 0.5 \vert \qquad ( 9 )$$

where S(t) is the stochasticity dimension at timestep t, A is the set of all possible actions, D(P) is Leik's ordinal dispersion index, which is a measure of the dispersion of a discrete distribution, Q^{π} (·|st) is the Q-function for state sₜ according to policy π. The stochasticity dimension may produce a scalar value in the [0, 1] interval, where a value of 1 indicates high stochasticity and a value of 0 indicates low stochasticity. The stochasticity dimension may be used to identify inherently stochastic regions of the environment, where different agent behavior outcomes may occur. For example, if the stochasticity dimension is high for a particular state, the agent 308 may be in a situation where its actions 312 are likely to have different outcomes each time they are performed.

The familiarity dimension may estimate the agent's epistemic uncertainty, which is the subjective uncertainty due to limited data or lack of experience with the environment. The familiarity dimension may be computed using an ensemble of predictive models. Each model in the ensemble may be trained independently, usually by random sub-sampling of a common replay buffer. The familiarity dimension may then be computed as the average of the pairwise distances between the predicted next-state vectors from each model in the ensemble. The familiarity dimension may produce a scalar value in the [0, 1] interval, where a value of 1 indicates high familiarity and a value of 0 indicates low familiarity. The familiarity dimension may be used to identify less-explored, unfamiliar parts of the environment where the agent 308 is more uncertain about what to do. For example, if the familiarity dimension is high for a particular state, such high value may indicate that the agent 308 has not seen this state before or it has not seen many examples of this state. The familiarity dimension may also be used to identify good intervention opportunities, as it indicates regions of the environment that need further exploration. For example, if the familiarity dimension is high for a particular region of the environment, the agent 308 may not be very familiar with this region and could benefit from further exploration.

In an aspect, the IxDRL framework 300 may provide a method to analyze an RL agent's behavior in a task by clustering traces based solely on interestingness. The aforementioned method may enable the identification of distinct competency-controlling conditions that lead to different behavior patterns. The IxDRL framework 300 may first collect traces of the agent's behavior in the task. The IxDRL framework 300 may implement this step by deploying the agent 308 in the environment a number of times under different initial conditions. Next, the interestingness analysis module 250 may calculate the interestingness of each trace. In an aspect, the interestingness analysis module 250 may implement this step by using the interestingness dimensions 306 described herein. In addition, the interestingness analysis module 250 may cluster the traces based on their interestingness. In an aspect, the interestingness analysis module 250 may implement this step using a variety of clustering algorithms, such as, but not limited to, k-means clustering or hierarchical clustering. Finally, the interestingness analysis module 250 may analyze the clusters to identify distinct competency-controlling conditions. In an aspect, the interestingness analysis module 250 may implement this step by examining the interestingness dimensions 306 of each cluster and by identifying the dimensions 306 that are most different between the clusters.

Once the distinct competency-controlling conditions have been identified, they may be used to better understand the agent's behavior and to develop strategies for improving its competence. For example, if one cluster contains traces where the agent 308 is making a lot of mistakes, such mistakes may indicate that the agent 308 is not competent in the conditions associated with that cluster. The agent's training regimen can then be modified to focus on improving its performance in those conditions.

In an aspect, the interestingness analysis module 250 may perform interestingness analysis along several dimensions 306 on the interaction data 302, resulting in a scalar value for each timestep of each trace. The resultant scalar value may be used to represent the degree of interestingness of the interaction data at that timestep. There are a number of different ways to generate a scalar value associated with an interestingness dimension. One common approach is to use a statistical measure, such as the mean or median. For example, the mean confidence value for a trace could be used to represent the overall confidence of the agent 308 at each timestep. The resultant scalar value is referred to as the interestingness data 304. The competency assessment module 252 may perform competency assessment based on the interestingness data 304 using various techniques. The IxDRL framework 300 may be designed to provide end-users of deep RL systems with a deeper understanding of the competence of their agents.

Furthermore, in an aspect, the IxDRL framework 300 may provide a method to discover which task elements impact agent's behavior the most and under which circumstances. In an aspect, this method may be implemented by the competency assessment module 252. In an aspect, the competency assessment module 252 may use SHAP values to perform global and local interpretation for competency assessment. SHAP is a technique for explaining the predictions of machine learning models. SHAP technique works by attributing the prediction of a model to each of the input features. SHAP technique may allow the competency assessment module 252 to identify which features are most important for the model's 206 prediction and how they impact the prediction. The competency assessment module 252 may use SHAP to identify the task elements that have the biggest impact on the agent's behavior. In an aspect, the competency assessment module 252 may achieve this by computing the SHAP values for each task element and each trace of the agent's behavior. The SHAP values may indicate how much each task element contributed to the agent's behavior in that trace. The global interpretation of the SHAP values may be used by the competency assessment module 252 to identify the task elements that are most important for the agent's behavior overall. The local interpretation of the SHAP values may be used by the competency assessment module 252 to identify the task elements that are most important for the agent's behavior in specific traces.

In an aspect, the competency assessment module 252 may use LIME technique to explain the relationship between environment features and interestingness dimensions (similarly to SHAP). LIME is a model-agnostic explanation technique that may be used to explain any machine learning model. LIME works by learning a local, interpretable surrogate model of the machine learning model in the vicinity of a given input. This surrogate model may then be used to explain the relationship between the input features and the output of the machine learning model. LIME is similar to SHAP in that both techniques may be used to explain the relationship between input features and output predictions. However, there are some key differences between the two techniques. SHAP is a global explanation technique. In other words, SHAP values may explain the relationship between input features and output predictions for the entire model. LIME, on the other hand, is a local explanation technique. In other words, LIME may explain the relationship between input features and output predictions for a specific input. This makes LIME more suitable for explaining individual predictions, while SHAP may be more suitable for explaining the overall behavior of the model.

In an aspect, the competency assessment module 252 may also use saliency maps technique to explain the relationship between environment features and interestingness dimensions. Saliency maps are a technique used to visualize which parts of an input are most important for a machine learning model's output. Saliency maps are typically generated by calculating the gradient of the model's output with respect to the input. This gradient may then be used to identify the pixels in the input that have the greatest impact on the model's output. In the context of interestingness analysis, saliency maps may be used to see which regions are most important to determine the interestingness associated with a given situation, for the different dimensions. To use saliency maps to explain the behavior of an RL agent, a dataset of states and actions taken by the RL agent may need to be collected first. The collected dataset may be used to train a saliency map model. Once the saliency map model is trained, such model may be used to generate saliency maps for new states.

The goal of competency analysis performed by the competency assessment module 252 may be to characterize RL agents' competence along various dimensions 306, each capturing a distinct aspect of the agent's interaction with the environment. The dimensions 306 of analyses are inspired by what humans—whether operators or teammates—might seek when trying to understand an agent's competence in a task.

Each interestingness dimension 306 may provide distinct targets of curiosity whose values might trigger a human to investigate the agent's learned policy further. Following are some non-limiting examples of interestingness dimensions 306 that are described in greater detail above: value, confidence, goal conduciveness, incongruity, riskiness, stochasticity. The competency assessment module 252 may provide a means for the agent 308 to perform competency self-assessment by analyzing the interestingness data 304 to identify cases that a human should be made aware of, and where user input might be needed. For example, the competency assessment module 252 may identify situations where the agent 308 is making risky decisions or where it is struggling to adapt to changes in the environment.

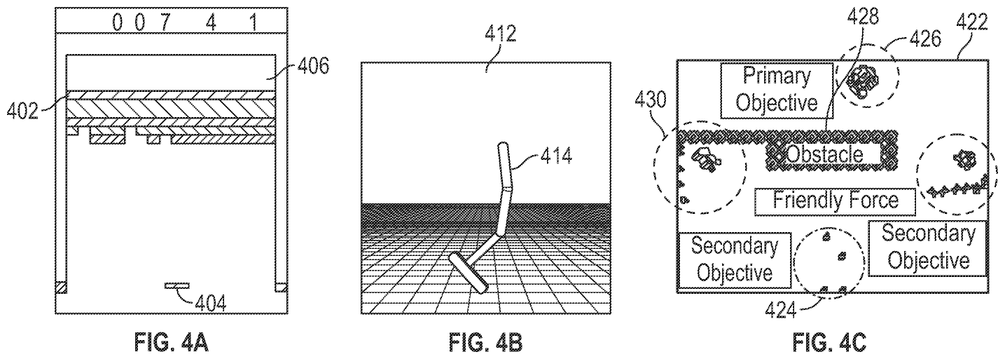

FIGS. 4A-4C are screenshots illustrating example scenarios where RL agents could be used according to techniques of this disclosure. FIG. 4A illustrates a first example of environment 402 in which competence of RL agents could be analyzed. The first environment 402 that the agent is operating in is a Breakout game. The agent controls the paddle 404 at the bottom of the screen and tries to hit the ball into the brick wall 406 at the top of the screen. The agent has five lives and loses a life if the ball falls into the ground without the paddle hitting it. The agent is rewarded for destroying bricks. The agent's observations are four time-consecutive stacked 84×84 grayscale frames transformed from the RGB game images. The agent has four possible actions: “noop”, “fire”, “right”, and “left”. The agent was trained using the distributional Q-learning approach for 2×106 timesteps. This approach approximates the Q function of each action using a discrete distribution over 51 values in the [−10, 10] interval. This first environment 402 is a good example of a complex and challenging environment for a RL agent. The agent has to learn to control the paddle in order to hit the ball into the brick wall, but the ball is bouncing around randomly and the speed of the ball increases as more bricks are destroyed. The agent also has to be careful not to lose all of its lives. The distributional Q-learning approach is a good approach for training an agent in this environment because it allows the agent to learn about the uncertainty in the environment. The agent may learn to predict the distribution of rewards that it will receive for each action, which allows it to make better decisions.

FIG. 4B illustrates a second example of environment 412 in which competence of RL agents could be analyzed. The second environment 412 that the agent is operating in is a simplified robotic Hopper 414 that can hop forward in the environment. The agent controls the torques on the three hinges connecting the four body parts, and the goal is to make hops that move the robot forward. The agent's observations are 11-dimensional, consisting of the positional values and velocities of the different body parts. The agent has three possible actions: torques on the three hinges. The agent was trained using the Model-Based Policy Optimization (MBPO) algorithm for 15×10⁴ timesteps. This algorithm learns an ensemble of dynamics models, each predicting the parameters of a multivariate Gaussian distribution over the next-step observation and reward given the current state and performed action. The policy is then optimized from rollouts produced by the learned models using Soft Actor-Critic (SAC). The second environment 412 is a good example of a challenging environment for a reinforcement learning agent. The agent has to learn to control the torques on the hinges in order to make the robot hop forward, but the robot is also subject to physical constraints and noise. The agent also has to be careful not to fall over. The MBPO algorithm is a good approach for training an agent in this environment because it allows the agent to learn about the dynamics of the environment. The agent may learn to predict the next state and reward given its current state and action, which allows it to make better decisions.

FIG. 4C illustrates a third example of environment 422 in which competence of RL agents could be analyzed. The third environment 422 that the agent is operating in is a StarCraft II game. The agent controls the blue force 424, which starts at the bottom of the map (see FIG. 4C). The agent's goal is to destroy the Primary Objective 426, which is a CommandCenter (CC) building located at the top of the map. The map is divided into three vertical “lanes,” each of which may be blocked by obstacles 428. The two side lanes contain Secondary Objectives 430, which are buildings guarded by red forces. Destroying the Red force defending one of the secondary objectives 430 causes the building to be removed from the map and replaced with additional blue units (reinforcements), with the type of reinforcements determined by the type of the building destroyed. Different types of units have distinct capabilities. The starting blue force consists of infantry (Marines or Marauders), but Blue can gain SiegeTanks (armored ground units) by capturing a Factory building, or Banshees (ground attack aircraft) by capturing a Starport. The Banshees are especially important because they can fly over ground obstacles and Red has no anti-air units to defend the primary objective. The third environment 422 has some unique aspects. The use of secondary objectives that provide reinforcements to the agent creates a trade-off for the agent, as it must decide whether to focus on capturing the primary objective or on capturing the secondary objectives to gain more powerful units. The presence of obstacles 428 and randomness in the initial state makes the scenario more challenging for the agent, as it must learn to adapt to different situations. The factored action space and the different types of units that the agent may control allows the agent to use a variety of strategies to achieve its goal.

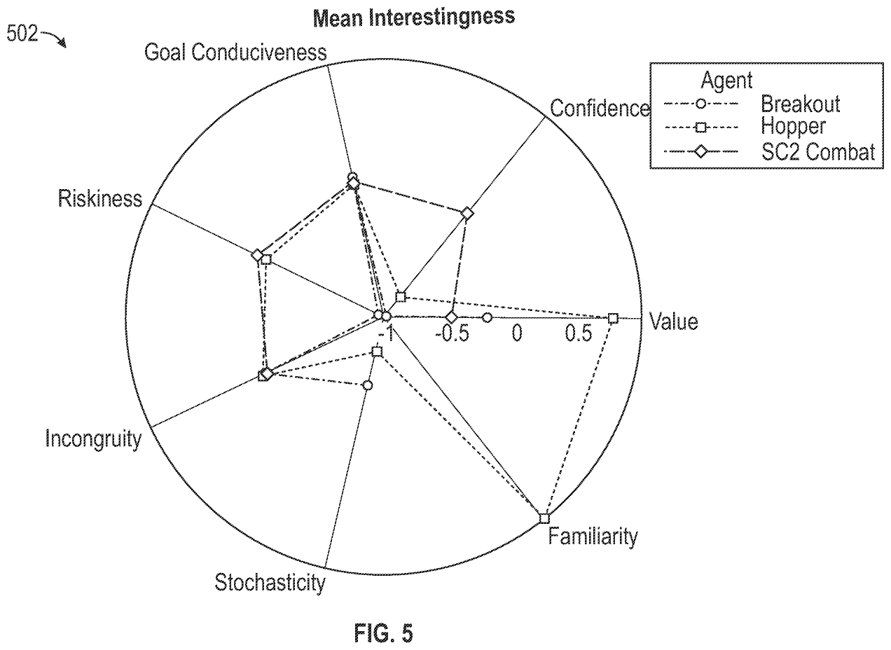

FIG. 5 is a conceptual diagram illustrating examples of interestingness profiles for each agent in the different scenarios of FIGS. 4A-4C according to techniques of this disclosure. More specifically, FIG. 5 shows a radar chart 502 for the mean interestingness (across all timesteps of all traces) resulting from analyzing each agent. Each shape represents the interestingness profile or “signature” for the behavior of the corresponding agent. As shown in FIG. 5, different scenarios lead to distinct profiles. The StarCraft2 (SC2) agent has a medium level of confidence, while the other agents are not so confident. This difference suggests that the SC2 task is more challenging for the agent, as it needs to make more complex decisions. The Hopper agent attributes a higher value to situations it encounters, compared to the other agents, indicating that the Hopper agent is more successful in achieving its goals. All agents attribute a neutral level of incongruity, which indicates that the reward signals in all scenarios are relatively predictable. All agents attribute a low level of stochasticity indicating that all scenarios are relatively deterministic. The Hopper agent attributes a high level of familiarity, which suggests that the Hopper agent has a good understanding of the dynamics of its environment. Overall, the results illustrated in FIG. 5 suggest that the SC2 agent is the most competent agent, followed by the Hopper agent. The Breakout agent is the least competent agent.

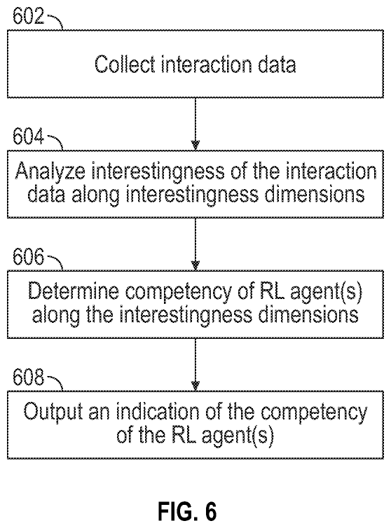

FIG. 6 is a flowchart illustrating an example mode of operation for a machine learning system, according to techniques described in this disclosure. Although described with respect to computing system 200 of FIG. 2 having processing circuitry 243 that executes machine learning system 204, mode of operation 600 may be performed by a computation system with respect to other examples of machine learning systems described herein.

In mode operation 600, processing circuitry 243 executes machine learning system 204. Machine learning system 204 may collect interaction data including one or more interactions between one or more Reinforcement Learning (RL) agents and an environment (602). The interaction data may include a variety of information, such as, but not limited to: the state of the environment at each timestep, the action taken by the agent at each timestep, the reward received by the agent at each timestep, and the like. Machine learning system 204 may analyzing interestingness of the interaction data along one or more interestingness dimensions (604) using the interestingness analyzer module 250. In an aspect, the interestingness analysis module may analyze trained RL policies along various interestingness dimensions, such as, but not limited to: confidence (how confident is the agent in its action selections?), riskiness (does the agent recognize risky or unfamiliar situations?), goal conduciveness (how “fast” the agent is moving towards or away from the goal?), incongruity (how resilient is the agent to errors and unexpected events?). Machine learning system 204 may next determine competency of the one or more RL agents along the one or more interestingness dimensions based on the interestingness of the interaction data (606). Machine learning system 204 may output an indication of the competency of the one or more RL agents (608). Competency awareness may be used by users to make more informed decisions about interventions, additional training, and other interactions in collaborative human-machine settings.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method comprising:
collecting interaction data comprising one or more interactions between one or more Reinforcement Learning (RL) agents and an environment;
analyzing interestingness of the interaction data along one or more interestingness dimensions;
determining competency of the one or more RL agents along the one or more interestingness dimensions based on the interestingness of the interaction data; and
outputting an indication of the competency of the one or more RL agents.

2. The method of claim 1, wherein the one or more interestingness dimensions comprise at least one of: value, confidence, goal conduciveness, incongruity, riskiness, stochasticity and familiarity.

3. The method of claim 2, wherein the confidence dimension indicates agent's confidence in action selection and wherein the riskiness dimension indicates an impact of the worst-case scenario at each step.

4. The method of claim 1, wherein the interaction data comprises timeseries data defining traces of behavior of the one or more RL agents in one or more tasks.

5. The method of claim 4, wherein analyzing interestingness of the interaction data along the one or more interestingness dimensions further comprises generating a scalar value associated with the one or more interestingness dimensions for each timestep of each trace of behavior of the one or more RL agents.

6. The method of claim 1, wherein determining competency of the one or more RL agents occurs before deployment in a real-world environment.

7. The method of claim 1, wherein determining competency of the one or more RL agents comprises identifying one or more competency-controlling elements of each task performed by the one or more RL agents.

8. The method of claim 7, wherein identifying one or more competency-controlling elements of each task comprises tracking performance of the one or more RL agents in real-world applications, or by running one or more simulations of interactions between the one or more RL agents and the environment.

9. The method of claim 1, wherein determining competency of the one or more RL agents comprises computing one or more SHAP (SHapley Additive explanations) values for each task element and each trace of the agent's behavior.

10. A computing system comprising:
an input device configured to receive interaction data comprising one or more interactions between one or more Reinforcement Learning (RL) agents and an environment;
processing circuitry and memory for executing a machine learning system, wherein the machine learning system is configured to:
analyze interestingness of the interaction data along one or more interestingness dimensions;
determine competency of the one or more RL agents along the one or more interestingness dimensions based on the interestingness of the interaction data; and
output an indication of the competency of the one or more RL agents.

11. The computing system of claim 10, wherein the one or more interestingness dimensions comprise at least one of: value, confidence, goal conduciveness, incongruity, riskiness, stochasticity and familiarity.

12. The computing system of claim 11, wherein the confidence dimension indicates agent's confidence in action selection and wherein the riskiness dimension indicates an impact of the worst-case scenario at each step.

13. The computing system of claim 10, wherein the interaction data comprises timeseries data defining traces of behavior of the one or more RL agents in one or more tasks.

14. The computing system of claim 13, wherein the machine learning system configured to analyze interestingness of the interaction data along the one or more interestingness dimensions is further configured to generate a scalar value associated with the one or more interestingness dimensions for each timestep of each trace of behavior of the one or more RL agents.

15. The computing system of claim 10, wherein the machine learning system configured to determine competency of the one or more RL agents is configured to determine competency of the one or more RL agents before deployment of the one or more RL agents in a real-world environment.

16. The computing system of claim 10, wherein the machine learning system configured to determine competency of the one or more RL agents is further configured to identify one or more competency-controlling elements of each task performed by the one or more RL agents.

17. The computing system of claim 16, wherein the machine learning system configured to identify one or more competency-controlling elements of each task is further configured to track performance of the one or more RL agents in real-world applications, or configured to run one or more simulations of interactions between the one or more RL agents and the environment.

18. The computing system of claim 10, wherein the machine learning system configured to determine competency of the one or more RL agents is further configured to compute one or more SHAP (SHapley Additive explanations) values for each task element and each trace of the agent's behavior.

19. Non-transitory computer-readable storage media having instructions encoded thereon, the instructions configured to cause processing circuitry to:
collect interaction data comprising one or more interactions between one or more Reinforcement Learning (RL) agents and an environment;
analyze interestingness of the interaction data along one or more interestingness dimensions;
determine competency of the one or more RL agents along the one or more interestingness dimensions based on the interestingness of the interaction data; and
output an indication of the competency of the one or more RL agents.

20. The non-transitory computer-readable storage media of claim 19, wherein the one or more interestingness dimensions comprise at least one of: value, confidence, goal conduciveness, incongruity, riskiness, stochasticity and familiarity.
